(19) United States
(12) Patent Application Publication
(10) Pub. No.: US 2024/0204357 A1
(43) Pub. Date: Jun. 20, 2024

(54) Electrode Assembly and Secondary Battery Including the Same

(71) Applicant: LG Energy Solution, Ltd., Seoul (KR)

(72) Inventors: Seongmo Koo, Daejeon (KR); Young Soo Kim, Daejeon (KR); Jaehee Kim, Daejeon (KR); Taehyun Kim, Daejeon (KR); Kwan Soo Lee, Daejeon (KR); Byeongjoon Lee, Daejeon (KR)

(73) Assignee: LG Energy Solution, Ltd., Seoul (KR)

(21) Appl. No.: 18/526,218

(22) Filed: Dec. 1, 2023

(30) Foreign Application Priority Data
Dec. 1, 2022 (KR) 10-2022-0165667

(51) Int. Cl. H01M 50/46; H01M 50/431; H01M 50/457; H01M 50/466; H01M 50/489

(52) U.S. Cl. CPC H01M 50/461; H01M 50/431; H01M 50/457; H01M 50/466; H01M 50/489

(57) ABSTRACT

A jelly-roll type electrode assembly includes a first separator, a second separator, a negative electrode, and a positive electrode. The first separator and second separator are positioned adjacent each other in a separator overlapping portion and extend with at least three layers in a first direction toward a core of the electrode assembly between an inner surface of the positive electrode and an outer surface of the negative electrode. An adhesive tape is located in at least one of a location between the outer surface of the positive electrode and an inner surface of the first separator, and a location between an outer surface of the negative electrode and the inner surface of the first separator.

### CROSS-REFERENCE TO RELATED APPLICATIONS

This application claims priority to Korean Patent Application No. 10-2022-0165667 filed in the Korean Intellectual Property Office on Dec. 1, 2022, the entire contents of which are incorporated herein by reference.

### TECHNICAL FIELD

The present invention relates to an electrode assembly and a secondary battery including the same. Specifically, the present invention relates to an electrode assembly capable of preventing damage from a swelling of the electrode assembly to both a negative electrode and a separator positioned at an end portion of a positive electrode. Additionally, a secondary battery implements such an electrode assembly the same.

### BACKGROUND ART

In general, a secondary battery refers to a battery that is chargeable and dischargeable unlike a primary battery that is not chargeable. A secondary battery is widely used in the field of high-tech electronic devices such as phones, laptop computers, and camcorders.

The stability of a secondary battery may be measured by a stability test in which one surface of the secondary battery is compressed with a press to measure an internal short.

Depending on a shape of a battery case, a secondary battery may be classified into a cylindrical battery, a prismatic battery in which an electrode assembly is embedded in a cylindrical or prismatic metal battery case, and a pouch-type battery in which an electrode assembly is embedded in a pouch-type battery case made of an aluminum laminate sheet.

An electrode assembly embedded battery case of a chargeable/dischargeable power generating device typically has a structure in which a positive electrode, a separator and a negative electrode are stacked, and is classified as a folding-type electrode assembly (jelly-roll). Jelly-rolls include a separator interposed between a positive electrode and a negative electrode, each of which is formed in a long sheet coated with an active material. The positive electrode, the separator, and the negative electrode are wound, and a stack-type electrode assembly in which a plurality of positive electrodes and negative electrodes having predetermined sizes are sequentially stacked with separators interposed therebetween. The jelly-roll has advantages in that it is easy to manufacture and has a high energy density per weight.

A jelly-roll type electrode assembly may be formed by winding a positive electrode and a negative electrode. Sometimes, a separator is interposed between the positive and negative electrodes; however, as the charging/discharging cycle is repeated hundreds to thousands of times, the jelly-roll type electrode assembly contracts and expands, which results in a bending deformation of an end portion of the positive electrode. Such bending may result in cracks, disconnections, and/or shorts to greatly impair the safety of the secondary battery.

### SUMMARY OF THE INVENTION

The present invention has been made in an effort to provide an electrode assembly capable of preventing an electrode end from cracking a separator and another electrode surface during contraction/expansion of the electrode resulting from charging/discharging of a secondary battery, and a secondary battery including the same.

An exemplary embodiment of the present invention provides a jelly-roll type electrode assembly including a first separator; a second separator; a negative electrode; and a positive electrode; wherein the first separator and second separator are positioned adjacent each other in a separator overlapping portion and extend with at least three layers in a first direction toward a core of the electrode assembly between an inner surface of the positive electrode and an outer surface of the negative electrode, and wherein an adhesive tape is located in at least one of a location between the outer surface the positive electrode and an inner surface of the first separator, and a location between an outer surface of the negative electrode and the inner surface of the first separator.

Another exemplary embodiment of the present invention provides a secondary battery including: the electrode assembly, a battery case having an opening on at least one surface and configured to accommodate the electrode assembly, and a cap assembly joined to an opening surface of the battery case.

Still another exemplary embodiment of the present invention provides a battery pack including the secondary battery.

Yet another exemplary embodiment of the present invention provides a vehicle including the battery pack.

According to the exemplary embodiment of the present invention, the separator located in the center direction of the jelly-roll structure is provided in three or more layers at a portion corresponding to an end portion of a portion where the winding of the positive electrode begins. As a result, cracking of the negative electrode is prevented at a portion in contact with the end portion of the positive electrode and disconnections or shorts are prevented, leading to improvement in safety of the secondary battery.

In addition, according to the exemplary embodiment of the present invention, the separator is overlapped in three or more layers on one surface of the positive electrode, and the separator and the adhesive tape are overlapped in two layers on the other opposing surface of the positive electrode, thereby preventing damage to the separator due to sliding of the positive electrode to prevent potential internal shorts of the secondary battery.

The adhesive tape having a porous structure between the separator and the negative electrode is located on the other surface of the positive electrode, so that lithium ions of the negative electrode can migrate smoothly through the separator and the adhesive tape, thereby preventing a decrease in capacity of the secondary battery due to the adhesive tape.

### BRIEF DESCRIPTION OF THE DRAWINGS

FIG. 1 is a perspective view of an electrode assembly according to an exemplary embodiment.

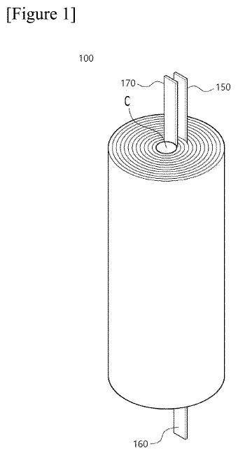

FIG. 2 is a top view of a jelly-roll type electrode assembly including a separator overlapping portion according to an exemplary embodiment;

FIG. 3 is an enlarged top view of a portion of the assembly of FIG. 2;

FIG. 4 is a partially exploded top view of the separator overlapping portion within the assembly portion of FIG. 3;

FIG. 5 is a partially exploded top view of a separator overlapping portion of the jelly-roll type electrode assembly according to another exemplary embodiment.

FIG. 6 is a side cross-sectional view of a secondary battery according to an exemplary embodiment.

FIG. 7 is a perspective view of a battery pack according to an exemplary embodiment of the present invention.

FIG. 8 is a perspective view of a vehicle according to an exemplary embodiment of the present invention.

FIG. 9 is a CT image showing results of cycle stability evaluation for secondary batteries according to exemplary embodiments.

FIG. 10 is a CT image showing results of cycle stability evaluation for secondary batteries according to other exemplary embodiments.

FIG. 11 shows a method for evaluating whether a separator at a core part of a jelly-roll type electrode assembly according to an exemplary embodiment of the present invention has been damaged.

### DETAILED DESCRIPTION

The detailed description of the present invention is intended to completely explain the present invention to one skilled in the art. Throughout the specification, unless explicitly described to the contrary, when one component “comprises” or “includes” another component, or is “characterized by” having a certain structure and a certain shape, other components, structures, and shapes not disclosed may be included without being excluded.

The present invention may be variously modified and may have various exemplary embodiments, and specific exemplary embodiments will be described in detail in the detailed description. However, the description of the exemplary embodiments is not intended to limit the contents of the present invention, but it should be understood that the present invention includes all modifications, equivalents and alternatives falling within the spirit and technical scope of the present invention.

Hereinafter, the present invention will be described in detail with reference to the drawings. However, it should be noted that the drawings are provided for illustrating the present invention, and the scope of the present invention is not limited by the drawings.

An electrode assembly 100 according to an exemplary embodiment of the present invention is a chargeable/dischargeable power generating device including a positive electrode 110, a negative electrode 120, and separators 130 and 140 located between the positive electrode 110 and the negative electrode 120. The separators may also be positioned on one surface of the positive electrode 110 and/or on one surface of the negative electrode 120, or in any combination thereof.

In an exemplary embodiment, the electrode assembly 100 may include a jelly-roll structure in which the positive electrode 110, the first separator 130, the negative electrode 120, and the second separator 140 are stacked and then wound. That is, before winding the electrode assembly 100, the positive electrode 110, the first separator 130, the negative electrode 120, and the second separator 140 may be stacked sequentially.

One end portion 110a of the positive electrode may extend in a longitudinal direction and may define a free-edge shape. As such, an area of an extraneous uncoated portion of a positive electrode current collector can be reduced to promote cost savings, and a slitting process can be performed after forming an active material layer on an electrode, so that a roll-to-roll process including the slitting process and a winding process can be performed more efficiently.

The slitting process is a process of cutting electrodes to a certain width using a cutter. Such a width may correlate to the height of the electrode assembly.

The roll-to-roll process can refer to any process using rolls. For example, when manufacturing electrode assemblies, the electrodes and separators are provided on rolls. The electrodes and separator are fed to the winding core as they are unwound from the roll and can be wound around the winding core.

The winding process refers to a process in which the electrode and the separator are wound in the winding core. The winding core may be removed after manufacturing the electrode assembly.

The positive electrode 110 may include a positive electrode current collector 111, a positive electrode active material layer, and a positive electrode uncoated portion. The positive electrode current collector 111 is not particularly limited as long as it has conductivity without causing a chemical change in the battery. Specifically, for the positive electrode current collector 111, stainless steel, aluminum, nickel, titanium, fired carbon, aluminum, or stainless steel, each of which may be surface-treated with carbon, nickel, titanium, silver, or the like, or other similar materials, may be used. As such, the positive electrode current collector 111 may be provided in the form of surface-treated stainless steel, aluminum foil, or the like.

The positive electrode current collector 111 may typically have a thickness of 3 to 50 μm, and a surface of the current collector may be formed with microscopic irregularities to enhance adhesion of the positive electrode active material. For example, the positive electrode current collector may be used in various forms such as a film, a sheet, a foil, a net, a porous body, a foamed body, and a non-woven fabric body.

The positive electrode 110 is coated with a positive electrode active material on one or more of both surfaces of the positive electrode current collector 111. A region coated with the positive electrode active material is defined as a positive electrode active material layer 112, and a region not coated with the positive electrode active material is defined as a positive electrode uncoated portion. Since the positive electrode active material layer 112 is not applied to the positive electrode uncoated portion, a first electrode tab 150 can be bonded to the positive electrode current collector 111 at the positive electrode uncoated portion.

The positive electrode active material may include a lithium cobalt oxide with a high operating voltage and excellent capacity characteristics, a lithium nickel oxide with a high reversible capacity that is easier to implement with a large-capacity battery, a lithium nickel cobalt oxide where a part of the nickel is substituted with cobalt, a lithium nickel cobalt metal oxide where a part of the nickel is substituted with manganese, cobalt, or aluminum, a lithium manganese-based oxide having a high thermal stability and a low cost, a lithium iron phosphate having a high stability, and the like.

The positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide represented by chemical formula Li₁₊ₓMn₂₋ₓO₄ (0≤x≤0.33) such as LiMnO₃, LiMn₂O₃ and LiMnO₂; a lithium copper oxide (Li₂CuO₂); a vanadium oxide such as LiV₃O₈, V₂O₅ and Cu₂V₂O₇; a Ni-site type lithium nickel oxide represented by chemical formula LiNi_{1-y}M_{y}O₂ (where M is at least one selected from the group consisting of Co, Mn, Al, Cu, Fe, Mg, B, and Ga, and satisfies 0.01≤y≤0.3); a lithium manganese composite oxide represented by chemical formula LiMn_{2-z}M₂O₂ (where M is at least one selected from the group consisting of Co, Ni, Fe, Cr, Zn and Ta, and satisfies 0.01≤z≤0.1) or Li₂Mn₃MO₈ (where M is at least one selected from the group consisting of Fe, Co, Ni, Cu and Zn.); and/or LiMn₂O₄ in which a part of Li of the chemical formula is substituted with an alkaline earth metal ion, or the like, but is not limited thereto. The positive electrode may be Li metal.

According to an exemplary embodiment of the present invention, the positive electrode active material layer 112 may further include a positive electrode conductive material and a positive electrode binder. The positive electrode conductive material imparts conductivity to the electrode, and can be used without limitations as long as it does not cause a chemical change while conducting electricity in a battery. Specific examples of the positive electrode conductive material may include graphite, such as natural graphite or artificial graphite; a carbon-based material such as carbon black, acetylene black, Ketjen black, channel black, furnace black, lamp black, thermal black, and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative. Other materials similar to the foregoing, as well as any combination of such materials, may be used as the positive electrode conductive material.

The positive electrode binder serves to improve attachment between particles of the positive electrode active material and adhesive force between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

The negative electrode 120 may include a negative electrode current collector 121, a negative electrode active material layer, and a negative electrode uncoated portion. The negative electrode current collector 121 may include a thin metal plate with excellent conductivity, for example, a copper (Cu) or nickel (Ni) foil.

The negative electrode 120 is coated with a negative electrode active material on one or both surfaces of the negative electrode current collector 121. The negative electrode active material layer 122 is formed by coating or applying the negative electrode active material to the negative electrode 120, and the negative electrode uncoated portion is a region where the negative electrode active material is not coated or applied to the negative electrode 120 and the negative electrode current collector is exposed. Since no negative electrode active material is applied to the negative electrode uncoated portion, a second electrode tab 160 can be bonded to the negative electrode current collector 121 at the negative electrode uncoated portion.

The negative electrode active material may be, for example, a carbon material such as crystalline carbon, amorphous carbon, carbon composite, carbon fiber, lithium metal, a lithium alloy, and/or the like. In this case, the negative electrode active material may further include, for example, non-graphite-based SiO (silica), SiC (silicon carbide), or the like for high-capacity designs.

According to an exemplary embodiment of the present invention, the negative electrode active material layer 122 may include a negative electrode active material including one or more materials selected from the group consisting of a silicon-based material and a carbon-based material. In addition, the negative electrode active material layer 122 may further include a negative electrode conductive material and a negative electrode binder, and for the negative electrode active material, the negative electrode conductive material, and the negative electrode binder may be made from materials known in the art.

According to an exemplary embodiment of the present invention, a material for the negative electrode current collector 121 is not particularly limited as long as it conducts electricity without causing a chemical change in the battery. For example, for the negative electrode current collector 121, materials such as copper, stainless steel, aluminum, nickel, titanium, fired carbon, aluminum or stainless steel, each surface-treated with carbon, nickel, titanium, silver, or the like, may be used. Specifically, transition metals that adsorb carbon well, such as copper and nickel, may be used for the negative electrode current collector 121. A thickness of the negative electrode current collector 121 may be 6 μm or greater and 80 μm or less. However, the thickness of the negative electrode current collector 121 is not limited thereto.

According to an exemplary embodiment of the present invention, the negative electrode binder may include at least one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-mentioned materials in which a hydrogen is substituted with Li, Na, Ca, etc., and may also include various copolymers thereof.

According to an exemplary embodiment of the present invention, a material for the negative electrode conductive material is not particularly limited as long as it conducts electricity without causing a chemical change in the battery. For example, materials like graphite such as natural graphite or artificial graphite; carbon black such as acetylene black, Ketjen black, channel black, furnace black, lamp black, and thermal black; a conductive fiber such as a carbon fiber and a metal fiber; a conductive tube such as a carbon nanotube; metal powders such as fluorocarbon, aluminum, and nickel powder; a conductive whisker such as zinc oxide and potassium titanate; a conductive metal oxide such as titanium oxide; a conductive material such as polyphenylene derivative, and the like may be used as the negative electrode conductive material.

The first electrode tab 150 and the second electrode tab 160 serve to transfer electrons collected in the current collectors to an external circuit, and may protrude in opposite directions with respect to the electrode assembly of the jelly-roll structure.

The separators 130 and 140 can prevent internal shorts that may occur when the positive electrode 110 and the negative electrode 120 come into contact. The separators 130 and 140 separate the negative electrode 120 and the positive electrode 110 and provide a migration path of lithium ions, in which many common separator materials may be used as long as the separator material has a high moisture-retention ability for an electrolyte as well as a low resistance to migration of electrolyte ions.

The separators 130 and 140 may include a porous material to facilitate migration of ions between electrodes. In an exemplary embodiment, the separators 130 and 140 may include a base layer made of a porous material. The base layers 131 and 141 may include, for example, any material selected from the group consisting of polyethylene (PE), polystyrene (PS), polypropylene (PP), and a copolymer of polyethylene (PE) and polypropylene (PP).

Alternatively, for the base layers 131 and 141, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a typical porous non-woven fabric, for example, a non-woven fabric formed of high melting point glass fibers, polyethylene terephthalate fibers, or the like may be used. In addition, the separator may typically have a thickness of 10 μm or greater and 20 μm or less. A separator in which the above-described separator material is used as a base layer may include a slurry coated on the base layer, the slurry containing a ceramic component or a polymer material, such that the slurry secures heat resistance or mechanical strength. The separator may have a single layer or multilayer structure.

In another exemplary embodiment, the separators 130 and 140 may include a safety reinforced separator (SRS). Specifically, the separators 130 and 140 may include base layers 131 and 141 made of a porous material and coating layers 132 and 142 coated and formed on the base layers by applying a mixed slurry of inorganic particles and a binder polymer. Preferably, the coating layers 132 and 142 includes ceramic particles and has a uniform pore structure formed by an interstitial volume between the ceramic particles that are components of an active layer, in addition to a pore structure of the separator base itself.

The coating layers 132 and 142 may include ceramic particles including at least one selected from the group consisting of alumina, silica, TiO₂, SiC and MgAl₂O₄. Such coating layers are included, at least in part, to enhance the safety of the electrode assembly. The coating layer may further include a lithium salt.

In another exemplary embodiment, the separators 130 and 140 may include the coating layers 132 and 142 provided on at least one surface thereof, respectively, and the coating layers 132 and 142 include an inorganic component, a binder component, and a lithium salt. When the separators include the components described, the increase in internal resistance is not caused by elution of the lithium salt contained in the coating layers, despite the fact that the binder for improving adhesion to the electrode and the inorganic component for improving the mechanical strength of the separators are included, such that the cell stability is excellent.

Because the electrolyte solution impregnation level of the electrodes facing the separators 130 and 140 can be increased, the electrode assembly's lifespan can be increased. Specifically, the coating layers 132 and 142 may include an inorganic component, and the coating layers 132 and 142 including the inorganic component are advantageous in terms of thermal shrinkage, as compared with a separator made of a simple polymer material. Therefore, the separators 130 and 140 including the inorganic component may be softer at higher temperatures.

The lithium salt may be substantially the same as that contained in an electrolyte solution of a lithium secondary battery, and may be, for example, at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂) 2NLi, lithium chloroborane, lithium lower aliphatic carboxylate, and lithium tetraphenyl borate.

The inorganic component can be made from a variety of materials so long as the materials do not cause oxidation and/or reduction reactions, i.e., an electrochemical reaction with a positive electrode or negative electrode current collector within an operating voltage range of the battery (e.g., 0 to 5 V based on Li/Li+), and does not impair conductivity. Such materials may be, for example, at least one material selected from the group consisting of BaTiO₃, Pb(Zr,Ti)O₃(PZT), Pb₁₋ₓLaₓZr_{1-y}Ti_{y}O₃(PLZT), Pb(Mg₃Nb_{2/3})O₃—PbTiO₃(PMN-PT), hafnia (HfO₂), SrTiO₃, SnO₂, CeO₂, MgO, NiO, CaO, ZnO, ZrO₂, Y₂O₃, Al₂O₃, and TiO₂.

The binder may be made from a variety of materials so long as it is not easily dissolved by the electrolyte solution while exhibiting a bonding force between an electrode stacked on the separator, an inorganic component, and a lithium salt in the mixed coating layer. For example, the binder may be at least one of the materials selected from the group consisting of polyvinylidene fluoride (PVdF); polyvinylidene fluoride-co-hexafluoropropylene; polyvinylidene fluoride-co-trichloroethylene; polyvinylidene fluoride chlorotrifluoroethylene (PVdF-CTFE); polymethyl methacrylate; polyacrylonitrile; polyvinylpyrrolidone; polyvinylacetate; polyethylene-co-vinylacetate copolymer; polyethyleneoxide; cellulose acetate; cellulose acetate butyrate; cellulose acetate propionate; cyanoethylpullulan; cyanoethyl polyvinyl alcohol; cyanoethyl cellulose; cyanoethyl sucrose; pullulan; carboxylmethyl cellulose; acrylonitrile-styrene-butadiene copolymer; and polyimide, and preferably may be PVdF or PVdF-CTFE.

In an exemplary embodiment of the present invention, the positive electrode 110 has a first (or radially inner) surface facing radially toward a center (C, or core part) of the jelly-roll structure and a second (or radially outer) surface facing radially away from the center (C) of the jelly-roll structure. The center (C) of the jelly-roll structure refers to a center of a circular structure when the jelly-roll structure is viewed from above, and refers to a region where the jelly-roll structure is initially wound.

The ‘core part’ is a hollow region within the core and it defines a winding axis of the electrode assembly, specifically a stacked structure of the wound first separator/negative electrode/second separator/positive electrode, and may refer to a region within 2 rotational turns of the positive electrode from one end portion, in the longitudinal direction, of the positive electrode located on the innermost side of the electrode assembly. In addition, “a turn,” such as “1 turn,” may refer to a length of material required to wind an electrode or separator included in an electrode assembly 360° about itself from a reference point, and the length may be determined depending on an outer diameter of a winding core used for winding the electrode assembly, a thickness of the electrode or separator, and the number of windings of the electrode or separator located on an inner side. For example, 1 turn of the positive electrode may refer to a length required to wind the positive electrode 360° from a longitudinal end portion of the positive electrode in a direction in which the jelly-roll type electrode assembly is wound, such a direction being either clockwise or counterclockwise when viewed from above.

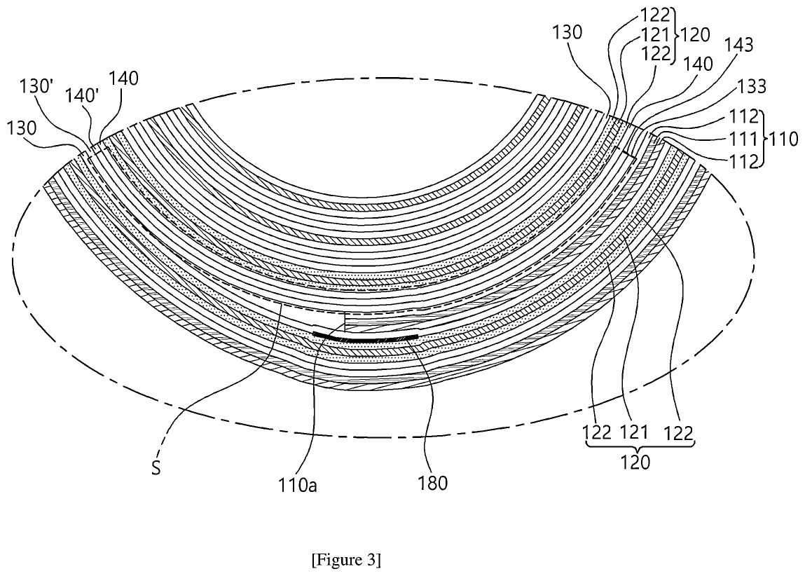

The electrode assembly 100 includes a separator overlapping portion S, illustrated in FIG. 3, where the first and second separators 130 and 140 are overlapped in three or more folds between one surface of the positive electrode 110 and the negative electrode 120, specifically, the negative electrode current collector (or negative electrode uncoated portion 121) at an end portion on the innermost side of the positive electrode 110, i.e., at an edge portion of the positive electrode adjacent to the center (C) of the jelly-roll structure. That is, the first and second separators 130 and 140 are arranged in three or more folds between the radially inner surface of the positive electrode 110 and the negative electrode 120 facing the radially inner surface of the positive electrode 110. An adhesive tape 180 is arranged between the radially outer surface of the positive electrode 110 and the negative electrode 120.

The electrode assembly 100 according to an exemplary embodiment of the present invention includes a separator overlapping portion S. The separator overlapping portion S suppresses sliding of the electrode during charging and discharging of the battery to prevent damage to the negative electrode and the separator when the electrode assembly deforms and swells due to contraction/expansion of the electrode. In addition, even if the separator becomes damaged, the separator overlapping portion can prevent an internal short between the positive electrode and the negative electrode, which improves the battery's stability and lifespan.

A length of the separator overlapping portion S may be defined as an arc having an arc length of approximately 50% of the circumference of the of the electrode assembly 100, i.e., the separator overlapping portion S may extend 180° around the electrode assembly. Preferably, the length of the separator overlapping portion S may extend over at least a half turn of the core part C of the electrode assembly 100. More preferably, the length of the separator overlapping portion S may be 6 mm or more from the longitudinal end portion 110a of the positive electrode 110 along the positive electrode 110 away from the core part C.

The electrode assembly 100 may be formed by fixing the separators 130 and 140 to a winding core, supplying the negative electrode 120 and the positive electrode 110 to the core in sequential order, and winding such components around each other to form a jelly-roll. Therefore, the first separator 130, the second separator 140, and the negative electrode 120 may be positioned toward a longitudinal end portion 110a of the positive electrode 110. In other words, the first separator 130, the second separator 140, and the negative electrode current collector 121 may extend to or past the longitudinal end portion 110a of the positive electrode 110, and the first separator 130 and the second separator 140 may extend to longitudinal end portion 120a of the negative electrode current collector 121. The longitudinal end portions 110a, 120a of the positive electrode 110 and the negative electrode 120, respectively, refer to end portions located adjacent to the winding core in the longitudinal direction of the positive electrode 110 and the negative electrode 120, respectively.

In the electrode assembly 100, the core part C may be formed at the center of the electrode assembly 100 by removing the winding core after the negative electrode 120, the positive electrode 110, and the separators 130 and 140 are wound.

At the radially inner part of the electrode assembly proximate the core part C, the first separator 130, the negative electrode 120, and the second separator 140 may extend past a longitudinal end portion 110a of the positive electrode 110 towards the core part C.

The first separator 130, the negative electrode 120 and the second separator 140 are initially wound together, and then the positive electrode 110 may start at longitudinal end portion 110a and be wound with the first separator 130, negative electrode 120, and the second separator 140. For example, after the first separator 130, the negative electrode 120, and the second separator 140 are wound at least one turn around the winding core, the first separator, the negative electrode, and the second separator may be wound together with the positive electrode 110. As such, near the core part C of the jelly-roll type electrode assembly, longitudinal end portions 120a, 133, and 144 of the first separator 130, the negative electrode 120, and the second separator 140, respectively, may be located on radially inner sides of the end portion 110a of the positive electrode.

The negative electrode 120 may have larger dimensions, i.e., length and width, than the dimensions of the positive electrode 110, and lengths and widths of the first separator 130 and the second separator 140 may also be greater than those of the positive electrode 110. When the first separator 130, the negative electrode 120, and the second separator 140 extend longer than the longitudinal end portion 110a of the positive electrode, lithium ions can be more easily transferred from the positive electrode to the negative electrode in a chemical reaction of the lithium-ion battery. When the dimensions of the negative electrode are larger, the surface area of the negative electrode configured to receive lithium ions increases, which prevents a decrease in charge/discharge efficiency and improves the stability and lifespan of the battery.

The first and second separators 130 and 140 located at longitudinal ends 120a, 110a the negative electrode 120 and the positive electrode 110, and may be bent once or more at the longitudinal end 120a of the negative electrode 120 located on the center side of the jelly-roll structure. In other words, the separators 130 and 140 are positioned circumferentially around the core part C of the electrode assembly 100, and are bent over each other at a bend point B such that the first and second separators 130 and 140 extend in both clockwise and counterclockwise directions from that bend point B.

The separators 130 and 140 are bent around each other at least once, and thus, have different winding directions (clockwise and counterclockwise directions) for at least a portion of the electrode assembly 100. The separators 130 and 140 may be stacked on one surface of the positive electrode 110. The separators 130 and 140 extending in a first clockwise direction at the end portion 120a of the negative electrode may be bent around each other to extend in an opposite counterclockwise direction relative to the winding axis, and may be stacked on one surface of the positive electrode 110. Therefore, the separators 130 and 140 may be overlapped to form four layers, and then the first separator 130 may be split into two layers around the positive electrode 110 to form three separator layers within the separator overlapping region S.

Continuing with this exemplary embodiment, the second separator 140′ located between the second separator 140 and the first separator 130 is the second separator 140′ that is located on one surface of the negative electrode 120 as a result of the second separator 140 being bent around itself once or more at the longitudinal end portion 110a of the positive electrode 110. As such, the portion of the second separator 140 located radially inwardly closest to the positive electrode 110 and the portion of the second separator 140′ located radially further from the positive electrode 110 may be in direct contact with each other.

Continuing with this exemplary embodiment, the separator overlapping portion S between the positive electrode 110 and the negative electrode 120 facing a radially inner surface of the positive electrode, and the separator overlapping portion may include the separators 130, 140 that are overlapped and arranged in three or more layers.

The separator overlapping portion S may refer to a part of a region where the separators are arranged in three or more layers, between the longitudinal end portion 110a of the positive electrode and the core C. Here, the separator overlapping portion S may refer to a region having one circumferential end Sₐ defined at a location where the presence of the three or more abutting layers of the separator terminates. The separator overlapping portion S may extend from that circumferential end Sₐ along those three abutting layers of separator to an opposing circumferential end S_{b}, where the opposing circumferential end S_{b} is defined by a location spaced away from the longitudinal end portion 110a of the positive electrode 110 by the same length that the one circumferential end Sₐ is spaced away from the longitudinal end portion 110a.

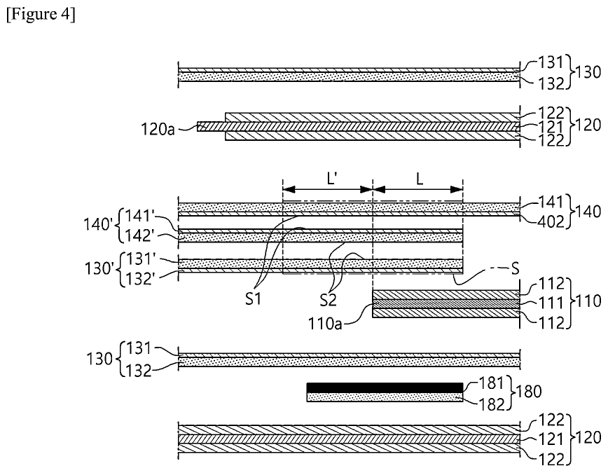

FIG. 4 illustrates various relationships between the electrodes and separators disclosed herein. As shown in that figure, the separator overlapping portion S may refer to a region extending between the one circumferential end Sₐ, which is spaced by a length L from the longitudinal end portion 110a of the positive electrode 110, to a point that is spaced by a length L′ in the opposite circumferential direction beyond the longitudinal end portion 110a, where the length L is equal to the length L′. That is, the separator overlapping portion S is a region having a length (L+L′=L+L=2L) and centered at the longitudinal end portion 110a of the positive electrode 110.

According to an exemplary embodiment of the present invention, the first separator 130 and the second separator 140 may extend from the longitudinal end portion 120a of the negative electrode near the core part C of the electrode assembly through the separator overlapping portion S. In some embodiments, the first separator 130 and the second separator 140 may extend past the longitudinal end portion 120a of the negative electrode further into the core part C.

Continuing with this exemplary embodiment, the first separator 130 and the second separator 140 are wound by a predetermined length in a winding direction, and then they may be wound together with the negative electrode 120 along the winding direction. The first separator 130 and the second separator 140 extending from the longitudinal end portion 120a of the negative electrode may include the first separator 130′ and second separator 140′ extending opposite to the winding direction. Such a bending and overlapping of separators forms the separator overlapping portion S.

The separator overlapping portion can be formed by bending the first and second separators 130, 140 around each other within the core (C) such that an additional auxiliary separator is not needed within the separator overlapping portion. With this, the separator overlapping portion may include three or more layers formed by two distinct separators 130, 140. In addition, when the separator overlapping portion is formed by overlapping the first separator 130 and the second separator 140 to extend from the longitudinal end portion 120a of the negative electrode 120, it is possible to prevent damage to the negative electrode and the separator from deformation of the electrode assembly due to contraction/expansion of the electrode. In addition, even if the separator is damaged, the separator overlapping portion can prevent an internal short by preventing the positive electrode 110 from contacting the negative electrode 120, so as to improve the stability and lifespan of the battery.

According to an exemplary embodiment of the present invention, the first separator and the second separator 130, 140 may extend in a first direction from the longitudinal end portion 120a of the negative electrode 120 toward the core part C of the electrode assembly, may be bent together in an opposite second direction to face a winding axis of the negative electrode, and may be overlapped and arranged between the positive electrode 120 and the second separator 140 facing the radially inner surface of the positive electrode 110, so as to form the separator overlapping portion S between the positive electrode 110 and the negative electrode 120 that faces the radially inner surface of the positive electrode 110. With this, it is possible to more easily control the separators constituting the separator overlapping portion, while allowing the separators constituting the separator overlapping portion to include three or more layers by the simple bending structure.

As described above, the separator overlapping portion S may be stacked in the following order (moving radially inwardly towards the core portion C): the first separator 130′, the second separator 140′, and the second separator 140. The separator overlapping portion S may include a first interface S1 and a second interface S2. The first interface S1 refers to a surface where the second separators 140, 140′ are in direct contact with each other, and the second interface S2 refers to a surface where the second separator 140′ and the first separator 130′ are in direct contact with each other.

The separator overlapping portion S may include the separators that are overlapped and arranged in three or more layers, may include one or more of each of the first separators 130 and the second separators 140 and 140′, and may include a first interface S1 where the second separator 140 and the second separator 140′ are in direct contact with each other, and a second interface S2 where the second separator 140′ and the first separator 130′ are in direct contact with each other. Since the separator overlapping portion S includes the plurality of interfaces, it is possible to easily control the direction the separators are facing, which in turn allows the coefficient of friction between the interfaces to be controlled due to the bending structure of the separators.

According to an exemplary embodiment of the present invention, the first interface S1 and the second interface S2 each may have a friction coefficient of 0.4 or greater. Specifically, the friction coefficients of the first interface S1 and the second interface S2 may be 0.42 or greater, 0.44 or greater, or 0.46 or greater. In other words, the separator overlapping portion S includes the overlapping structure of the plurality of separators such as the first separator and the second separator, rather than an overlapping structure of a single separator, and includes a plurality of interfaces at each of which the separators contact each other. Thus, the friction coefficients of the plurality of interfaces may be each controlled. When the friction coefficients of the first interface and the second interface satisfy the above ranges, it is possible to suppress the sliding of the positive electrode by the first separator and the second separator integrally formed with the separator overlapping portion during charging and discharging of the battery, and to prevent damage to the negative electrode and the separator from deformation of the electrode assembly due to contraction/expansion of the electrode. Here, the friction coefficient (u) may refer to a static friction coefficient measured in accordance with the ASTM D 1894 standard. Such a coefficient may be measured in a dry method and may have a larger value when measured by a wet method of immersing a specimen in distilled water or an electrolyte solution.

In another exemplary embodiment, the friction coefficient of the first interface and the second interface of the electrode assembly 100 may be different. Preferably, the friction coefficient of the first interface may be greater than the friction coefficient of the second interface. More preferably, the friction coefficient of the first interface may be 0.6 or greater, and the friction coefficient of the second interface may be 0.4 or greater. Specifically, the friction coefficients of the first interface S1 and the second interface S2 may be different from each other based on the type and orientation of the first and second separators 130, 130′, 140, 140′ within the first and second interfaces S1, S2. More specifically, the friction coefficient of the first interface S1 may be 0.62 or greater, or 0.66 or greater, and the friction coefficient of the second interface S2 may be 0.42 or greater, 0.44 or greater, or 0.46 or greater. When the friction coefficients between the interfaces of the separators included in the separator overlapping portion are controlled within such ranges, it is possible to suppress the sliding of the electrode during charging and discharging of the battery, and to prevent damage to the negative electrode and the separator from deformation of the electrode assembly due to contraction/expansion of the electrode. In addition, even if the separator is damaged, the separator overlapping portion can prevent an internal short between the positive electrode and the negative electrode to improve the battery stability and lifespan.

According to an exemplary embodiment of the present invention, each of the first separator 130 and the second separator 140 may include a coating layer provided on at least one surface thereof. Specifically, the first separators 130 and 130′ and the second separators 140 and 140′, where the prime number indicates the same separator is extending in an opposite direction to the winding direction due to the bending structure of the separators at the bend point B, may include the coating layers 132, 132′, 142 and 142′ provided on one least surface thereof, and the base layer 131, 131′, 141 and 141′, respectively, and may each have a friction coefficient within a specific range by controlling a component, a content, and a particle size of the coating layer. Specifically, a friction coefficient between the coating layer and the coating layer and a friction coefficient between the base layer and the base layer of the separator may be greater than a friction coefficient between the coating layer and the base layer. The friction coefficients may be measured in a dry method, but may have a more significant difference when immersed in distilled water or an electrolyte solution, i.e., when measured in a wet method.

When the coating layer is provided on at least one surface of each of the first separator 130 and the second separator 140, the friction coefficient between the interfaces of the separators included in the separator overlapping portion is controlled to a specific range by controlling the facing direction of the coating layers to suppress the sliding of the electrode during charging and discharging of the battery, and to prevent damage to the negative electrode and the separator from deformation of the electrode assembly due to contraction/expansion of the electrode.

According to an exemplary embodiment of the present invention, each of the first separator and the second separator may include a coating layer provided on at least one surface thereof. Specifically, referring to FIG. 4, the first separators 130 and 130′ and the second separators 140 and 140′ may have coating layers 132, 132′, 142 and 142′ provided on one surface, respectively. In addition, the surface of the first separator and the second separator provided with the coating layer may have a greater friction coefficient than the surface of the first separator and the second separator not provided with a coating layer. That is, the coating layer may increase the friction coefficient of the interface when provided on the separator. The friction coefficient between the interfaces of the separators included in the separator overlapping portion is controlled to a specific range by controlling the facing direction of the coating layers provided on one surface of each of the first separator 130 and the second separator 140 to suppress the sliding of the electrode during charging and discharging of the battery, and to prevent damage to the negative electrode and the separator from deformation of the electrode assembly due to contraction/expansion of the electrode.

According to an exemplary embodiment of the present invention, the first separator and the second separator may each have a friction coefficient within a specific range by controlling a component, a content, and a particle size of the coating layer.

According to an exemplary embodiment of the present invention, the first separator 130 and the second separator 140 may each include a coating layer provided on one surface thereof, and the first interface S1 may be an interface at which the coating layer of the second separator 140 and the coating layer of the second separator 140′ are in direct contact with each other. Specifically, referring to FIG. 4, the first separators 130 and 130′ and the second separators 140 and 140′ may have coating layers 132, 132′, 142 and 142′ provided on one surface thereof, respectively, and the first interface S1 may be an interface at which the coating layer 142 of the second separator and the coating layer 142′ of the second separator are in direct contact with each other. When the coating layer of the second separator and the coating layer of the second separator are in direct contact with each other, the friction coefficient between the coating layers of the separator may be greater than the friction coefficient between the base layers or the friction coefficient between the coating layer and the base layer, and the friction coefficient of the first interface may have a larger value than such other coefficients. When the coating layer of the second separator 140 and the coating layer of the second separator 140′ are in direct contact at the first interface, the friction coefficient between the interfaces of the separators included in the separator overlapping portion is higher, such that it is possible to suppress the sliding of the electrode during charging and discharging of the battery, and thus, to prevent damage to the negative electrode and the separator from deformation of the electrode assembly due to contraction/expansion of the electrode.

According to an exemplary embodiment of the present invention, the first separator 130 and the second separator 140 may each include a coating layer provided on one surface thereof, and the second interface S2 may be an interface at which a surface of the second separator 140 not provided with a coating layer and a surface of the first separator 130 not provided with a coating layer are in direct contact with each other. Specifically, referring to FIG. 4, the first separators 130 and 130′ and the second separators 140 and 140′ may have coating layers 132, 132′, 142 and 142′ provided on one surface thereof, respectively, and the second interface S2 may be an interface at which a surface of the second separator not provided with a coating layer, i.e., the second separator base layer 141′, and a surface of the first separator not provided with a coating layer, i.e., the first separator base layer 131′ are in direct contact with each other. When a surface of the second separator 140 not provided with a coating layer and a surface of the first separator not provided with a coating layer are in direct contact with each other, the friction coefficient between the base layer and the base layer of the separator may be greater than the friction coefficient between the coating layer and the base layer, and the friction coefficient of the second interface may be larger. When the uncoated surface of the second separator 140 not provided with a coating layer and the uncoated surface of the first separator 130 not provided with a coating layer are in direct contact with each other at the second interface, the friction coefficient between the interfaces of the separators included in the separator overlapping portion is higher, such that it is possible to suppress the sliding of the electrode during charging and discharging of the battery, and thus, to prevent damage to the negative electrode and the separator from deformation of the electrode assembly due to contraction/expansion of the electrode.

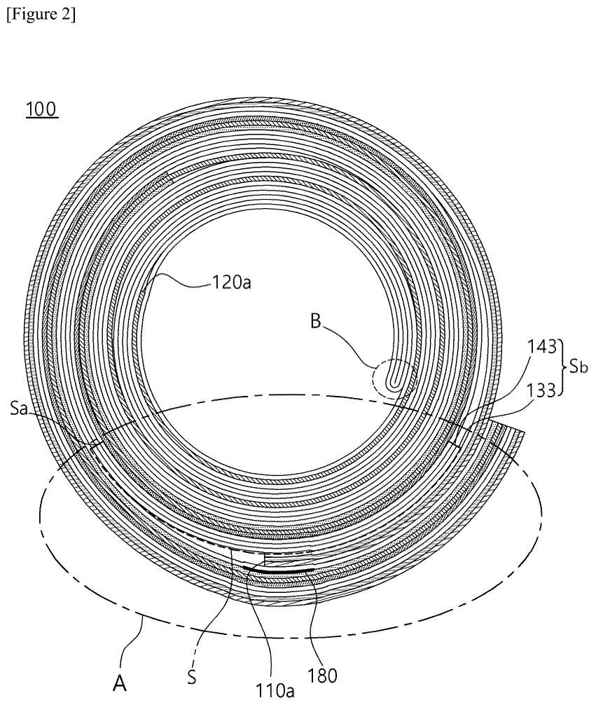

According to an exemplary embodiment of the present invention, the first interface may be an interface at which the second separator facing the radially inner surface of the positive electrode and the second separator extending from the longitudinal end portion of the negative electrode at the core part of the electrode assembly are in direct contact with each other. Specifically, referring to FIGS. 2 to 4, the second separator 140′ extending from the longitudinal end portion 120a of the negative electrode may be overlapped to form the separator overlapping portion S between the positive electrode 110 and the negative electrode 120 facing the radially inner surface of the positive electrode. Because the second separator 140 is located between the positive electrode 110 and the negative electrode 120 facing the radially inner surface of the positive electrode, the extended second separator 140′ may be in direct contact with the second separator 140 located between the positive electrode 110 and the negative electrode 120. That is, the first interface S1 at which the second separator 140 and the second separator 140′ extending from the longitudinal end portion 120a of the negative electrode at the core part of the electrode assembly contact each other. With this, it is possible to more easily control the facing direction of the separators constituting the separator overlapping portion and the frictional force at the interface while allowing the separators constituting the separator overlapping portion to include at least three layers by the simple bending structure.

According to an exemplary embodiment of the present invention, the second interface may be an interface at which the first separator extending from the longitudinal end portion of the negative electrode at the core part of the electrode assembly and the second separator extending from the longitudinal end portion of the negative electrode at the core part of the electrode assembly contact each other. Specifically, referring to FIGS. 2 to 4, the first separator 130 extending from the longitudinal end portion 120a of the negative electrode and the second separator 140′ extending from the longitudinal end portion of the negative electrode may be overlapped and arranged to form the separator overlapping portion S between the positive electrode 110 and the negative electrode 120 facing the radially inner surface of the positive electrode. In this case, the second interface S2 at which the first separator 130′ extending from the longitudinal end portion 120a of the negative electrode and the second separator 140′ extending from the longitudinal end portion 120a of the negative electrode contact each other. With this, it is possible to more easily control the facing direction of the separators constituting the separator overlapping portion and the frictional force at the interface while allowing the separators constituting the separator overlapping portion to be include at least three layers by the simple bending structure.

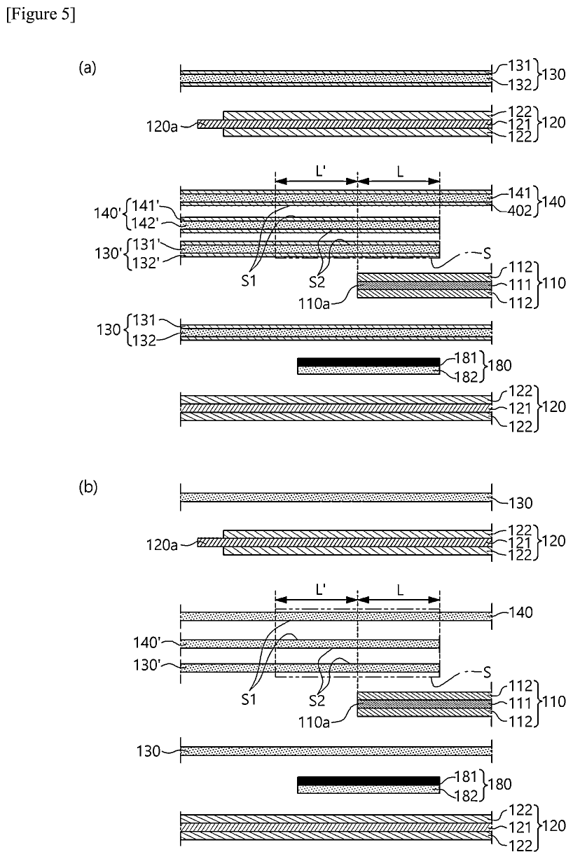

FIG. 5 schematically shows a separator overlapping portion of the jelly-roll type electrode assembly according to exemplary embodiments of the present invention. Specifically, part (a) of FIG. 5 schematically shows a separator overlapping portion of a jelly-roll type electrode assembly including a first separator and a second separator each having coating layers on both surfaces, and part (b) of FIG. 5 schematically shows a separator overlapping portion of a jelly-roll type electrode assembly including a first separator and a second separator, each without a coating layer.

According to an exemplary embodiment of the present invention, each of the first separator and the second separator may include a coating layer provided on at least one surface thereof. Specifically, referring to FIG. 3 and part (a) of FIG. 5, the first separators 130 and 130′ and the second separators 140 and 140′ may include the coating layers 132, 132′, 142 and 142′ provided on at least one surface thereof, respectively, and the base layers 131, 131′, 141 and 141′ may each have a friction coefficient within a specific range by controlling a component, a content, and a particle size of the coating layer. Specifically, a friction coefficient between the coating layer and the coating layer and a friction coefficient between the base layer and the base layer of the separator may be greater than a friction coefficient between the coating layer and the base layer. In addition, the friction coefficients may be measured in a dry method or a wet method, but the coefficient may change when immersed in distilled water or an electrolyte solution, i.e., when measured in a wet method.

When a coating layer is provided on at least one surface of each of the first separator and the second separator, the friction coefficient between the interfaces of the separators included in the separator overlapping portion is controlled to a specific range by controlling the facing direction of the coating layers provided on at least one surface of each of the first separator and the second separator. Controlling the orientation of such separators and coating layers suppresses the sliding of the electrode during charging and discharging of the battery, and prevent damages to the negative electrode and the separator from deformation of the electrode assembly due to contraction/expansion of the electrode.

According to an exemplary embodiment of the present invention, each of the first separator and the second separator may include a coating layer provided on at least one surface thereof, and the coating layer may include an inorganic component, a binder component, and a lithium salt. With such components, an increase in internal resistance is achieved, but such increase is not caused by the elution of the lithium salt contained in the coating layer, despite the fact that the binder for improving adhesion with the electrode and the inorganic component for improving the mechanical strength of the separator is included. Thus, the result is improved cell stability.

According to an exemplary embodiment of the present invention, a length of the separator overlapping portion S may be defined as an arc having an arc length of approximately 30% of the circumference of the electrode assembly i.e., the separator overlapping portion S may extend approximately 108° around the electrode assembly. Specifically, the length of the separator overlapping portion may be defined with an arc length of approximately 40% or more or 50% or more of the electrode assembly, i.e., the separator overlapping portion S may extend at least 144° around the electrode assembly. Said another way, the separators layers may be bent about themselves to form a separator overlapping portion S of at least a ⅓ turn or ½ turn an inner circumferential surface of the core part of the electrode assembly.

The circumference of the electrode assembly may refer to a circumference of the inner circumferential surface of the electrode assembly, and the ‘circumference of the inner circumferential surface’ may refer to a circumference of a virtual circle having a center point in the middle of the innermost separator layer and a radius between the center point and the innermost separator layer. For example, the circumference of the inner circumferential surface of the electrode assembly may be approximately 10 mm.

In addition, the length of the separator overlapping portion may refer to a length of L+L′=L+L=2L. That is, the first separator extending from the longitudinal end portion of the negative electrode at the core part of the electrode assembly and the second separator extending from the longitudinal end portion of the negative electrode at the core part of the electrode assembly may be arranged in an arc that covers at least approximately ⅙ or ¼ of the circumference of the electrode assembly measured between the positive electrode and the negative electrode facing the radially inner surface of the positive electrode. The length of the separator overlapping portion may be an arc that covers at least approximately ⅓ or ½ of the circumference of the electrode assembly. When the above-described length ranges are satisfied, the frictional force between the interfaces of the separators included in the separator overlapping portion can suppress the sliding of the electrode during charging and discharging of the battery, thereby preventing damage to the negative electrode and the separator when the electrode assembly contracts and expands.

According to an exemplary embodiment of the present invention, a distance between the longitudinal end portion # of the separator overlapping portion and the longitudinal end portion 110a of the positive electrode may be 3 mm or longer. Specifically, referring to FIG. 3, a distance L between the longitudinal end portion of the separator overlapping portion and the longitudinal end portion of the positive electrode may be 4 mm or longer, 5 mm or longer, or 6 mm or longer.

The first separator 130 extending from the longitudinal end portion 120a of the negative electrode 120 at the core part C of the electrode assembly and the second separator 140′ extending from the longitudinal end portion 120a may be arranged to extend at least 3 mm beyond the longitudinal end portion 110a of the positive electrode between the positive electrode 110 and the negative electrode 120 facing the radially inner surface of the positive electrode.

When the above-described dimensions are satisfied, even when there is a potential process error with respect to an introduction of the first separator and the second separator, the separator overlapping portion can be arranged between the positive electrode and the negative electrode facing the radially inner surface of the positive electrode. In addition, the frictional force between the interfaces of the separators can suppress the sliding of the electrode during charging and discharging of the battery, thereby sufficiently preventing damage to the negative electrode and the separator caused by the contraction/expansion of the electrode.

The electrode assembly 100 according to the present invention may further include a third electrode tab 170 at the core part (C). The third electrode tab 170 may be located at the longitudinal end portion 110a of the positive electrode 110.

Adhesive tape 180 is located on one surface of the first separator 130 (e.g., the radially outer surface) and one surface of the negative electrode 120 (e.g., the radially inner surface). The adhesive tape 180 may include a base layer having a porous structure, like the separators 130 and 140.

In the electrode assembly 100, the separators 130 and 140 may overlap to form at least three layers between the radially inner surface of the positive electrode 110 and the negative electrode 120. The first separator 130 and the adhesive tape 180 may overlap to form two layers between the radially outer surface 110b of the positive electrode 110 and the negative electrode 120.

Continuing with this embodiment, cracks and overheating that may occur from the end portion 110a of the positive electrode 110 can be prevented. Specifically, as the demand for high energy density design increases, the electrode tab (second electrode tab or in tap) is bonded to the core part C of the electrode assembly 100 or the negative electrode active material contains more SiO, thereby increasing the density of the positive electrode and the stress concentrated at a step portion of the positive electrode.

For example, the in-tap is an electrode tab located on one side of the negative electrode uncoated portion close to the core portion. In other words, the in-tap refers to the electrode tab closest to the longitudinal end portion of negative electrode forming the core portion.

The step portion of the positive electrode is a portion where a thickness of the positive electrode increases rapidly from approximately 100 μm to approximately 200 μm as the positive electrode is interposed at a beginning point of the electrode assembly, and thus, a physical step is formed within the jelly-roll type electrode assembly, and corresponds to the edge portion 113 of the positive electrode 110 in FIG. 4.

The stress concentrations experienced in the positive electrode increase at such a step portion of the positive electrode, and therefore, when a force is applied to the step portion due to the contraction and expansion process of the battery, the separator may become damaged at the step portion, thereby increasing the risk of ignition or other failure due to cracks or shorts. According to an exemplary embodiment of the present invention, as described above, the three-layer separator is arranged on the radially inner surface of the positive electrode 110 at the longitudinal end portion 110a of the positive electrode, and the two-layer separator and adhesive tape are arranged on the radially outer surface of the positive electrode 110 at the longitudinal end portion 110a. Therefore, damage to the separator at the step portion of the positive electrode is prevented and a stable buffering action is realized, such that potential cracks and shorts caused by repetitive contraction and expansion at the end portion of the positive electrode where stress is high can be prevented, and the risk of ignition due to cracks and shorts is minimized.

As repeated charging and discharging cycles proceed hundreds to thousands of times, contraction and expansion of the electrode may occur. Due to this, bending deformation may be caused at the edge portion of the positive electrode 110, which may crack the electrode. However, the three-layer separator is arranged on the radially inner surface of the positive electrode 110 at the edge portion of the positive electrode, and the two-layer separator and adhesive tape are arranged on the radially outer surface of the positive electrode 110 at the edge portion of the positive electrode, to prevent cracks, shorts, and ignition when the positive electrode expands and contracts. In particular, in the present exemplary embodiment, the three-layer separator is arranged on the radially inner surface and the two-layer separator and adhesive tape are arranged on the radially outer surface, rather than on the same surface of the positive electrode, so that cracks and shorts of the electrode can be prevented from occurring on either side.

The adhesive tape 180 according to an exemplary embodiment may include a porous base layer 181 and an adhesive layer 182 applied to one surface of the porous base layer. The adhesive layer 182 may be entirely stacked on one surface of the porous base layer 181, or the adhesive layer 182 may be stacked on only a portion of one surface of the porous base layer 181 in a pattern.

The porous base layer 181 of the adhesive tape 180 may be the same as the separator base layers 131 and 141 of the first separator 130 and the second separator 140, respectively. When the adhesive tape 180 includes the porous base layer and the adhesive layer 182, the adhesive layer 182 may include a material that facilitates migration of ions, specifically lithium ions, or the adhesive layer 182 may absorb an electrolyte solution and expand to form an ion migration path.

The adhesive tape 180, like the separators 130 and 140, facilitates migration of ions between electrodes, and thus, can prevent lithium ions from precipitating even when the secondary battery 1 is charged/discharged.

Alternatively, for the porous base layer 181, one or more films selected from the group consisting of an acrylic film, a polyolefin film, a polyamide film, a polycarbonate film, a polyurethane film, a cellulose acetate film, and a polyester film may be used, for example, but the present application is not limited thereto.

When a polyester film is used as the porous base layer 181, one or more films selected from the group consisting of a polyethylene terephthalate film, a polyethylene naphthalate film and a polybutylene terephthalate film may be used. When a cellulose-based porous base layer 181 is used as the porous base film, for example, a porous base layer 181 that includes, for example, a cellulose acetate resin or a cellulose alkylate resin, and is manufactured by applying a mixture including the resin to an extrusion or casting process may be used. As the cellulose alkylate, for example, cellulose acetate propionate, cellulose acetate butylate or the like may be used.

A method for manufacturing the porous base layer 181 by using the resin may manufactured from a variety of methods, and, for example, a usual film or sheet forming method such extruding or casting a raw material including the resin, and potential additives may be used.

When the porous base layer 181 as described above has a sheet or film shape, a thickness of the porous base layer 181 may be a variety of thickness, and may be, for example, about 10 to 200 μm, about 10 to 100 μm, about 10 to 50 μm, about 15 to 30 μm, or about 15 to 20 μm.

The adhesive layer may include polyethylene oxide (PEO, ether group). An electrostatic polar attraction acts between polyethylene oxide and the electrolyte solution, so the adhesive layer can attract the electrolyte solution flowing into the separator through the porous base layer and cause the electrolyte solution to be absorbed into the adhesive layer.

Specifically, the adhesive layer 182 may be represented by the following Formula 1.

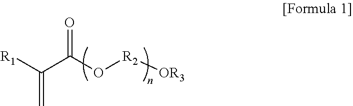

In Formula 1, R1 represents hydrogen or an alkyl group having 1 to 12 carbon atoms,

R2 represents an alkylene group having 1 to 6 carbon atoms,

R3 represents hydrogen, an alkyl group having 1 to 12 carbon atoms, an aryl group having 6 to 24 carbon atoms, or an arylalkyl group having 6 to 48 carbon atoms, and

n is 0 or greater.

In Formula 1, R1 is hydrogen or an alkyl group having 1 to 12, 1 to 8, or 1 to 4 carbon atoms, and may be, for example, hydrogen, a methyl group, an ethyl group, a propyl group, a butyl group, a pentyl group, a hexyl group, or the like, and is preferably hydrogen or a methyl group, but is not limited thereto.

In addition, in Formula 1, R2 is an alkylene group having 1 to 6, 1 to 4, or 1 to 2 carbon atoms, and may be, for example, ethylene or propylene, but is not limited thereto.

R3 represents hydrogen; an alkyl group having 1 to 12, 1 to 8, 1 to 6, or 1 to 4 carbon atoms; an aryl group having 6 to 24, 6 to 20, 6 to 18, or 6 to 12 carbon atoms; or an arylalkyl group having 6 to 48, 6 to 30, 6 to 24, or 6 to 18 carbon atoms, and may be, for example, hydrogen, a methyl group, an ethyl group, a propyl group, a phenyl group, a naphthal group, a butylphenol group, a pentylphenol group, a hexylphenol group, a heptylphenol group, an octylphenol group, a nonylphenol group, or the like.

In addition, n may be 0 or greater, for example, 1 or greater, or preferably 2 or greater.

In the secondary battery 1 according to the present invention, which is illustrated in FIG. 3, the two-layer first separator 130 and the adhesive tape 180 are overlapped along the radially outer surface of the positive electrode 110 to prevent damage to the separator due to the step portion of the positive electrode and the internal short of the secondary battery 1. Thus, the lithium ions of the positive electrode migrate to the negative electrode through the porous base layer and the electrolyte solution absorbed in the adhesive layer, so the secondary battery 1 according to the present invention can improve capacity reduction due to the adhesive layer.

Since the monomer represented by Formula 1 includes at least one oxygen atom and exhibits a very high polarity due to the high electronegativity of the oxygen atom, the adhesive layer including the monomer may have a high affinity with the polar electrolyte solution, and may expand when it contacts the electrolyte. The term “electrolyte solution” used herein may refer to, for example, a medium for ion conduction used in a secondary battery. In one example, the electrolyte may be an electrolyte solution that is a medium in a liquid state, but is not limited thereto. In the present specification, the electrolyte solution is also expressed as an electrolyte.

The adhesive tape 180 according to another exemplary embodiment may include a porous base layer 181 and a coating layer (not shown) obtained by applying slurry mixed with inorganic particles and a binder to one surface of the porous base layer 181. The adhesive tape 180 may have adhesive force due to the binder included in the coating layer. For example, for the adhesive tape 180, an organic solvent may be mixed with slurry, inorganic particles, and a binder, and the resulting slurry may be coated on one surface of the porous base layer 181, and then process conditions may be adjusted just before drying to induce phase separation, which causes the adhesive binder to come to the surface.

In another exemplary embodiment, the adhesive tape 180 may include a porous base layer 181, a coating layer including slurry mixed with both inorganic particles and a binder applied on one surface of the porous base layer 181, and an adhesive layer 182 applied to a surface of the coating layer and/or and another surface of the porous base layer 181. One surface of the coating layer on which the adhesive layer 182 is applied refers to an opposite surface to a surface directly contacting the base layer. The adhesive layer may have the same structure as that of the adhesive tape 180 described herein.

A stacking position of the adhesive layer 182 of the adhesive tape 180 may be determined such that the base layer 181 of the adhesive tape 180 and the positive electrode 110 can directly contact each other, or the coating layer and the negative electrode 120 can directly contact each other.

Continuing with this embodiment, the frictional force between the positive electrode 110, the negative electrode 120, and the adhesive tape 180 can be increased to prevent the negative electrode 120 and the positive electrode 110 from sliding, thereby preventing the core part C from collapsing or otherwise deforming.

The adhesive tape 180 may be bonded such that the coating layer and the adhesive layer directly contact the radially outer surface of the positive electrode 110, or may be bonded to one surface of the negative electrode 120 facing the radially outer surface of the positive electrode 110. Alternatively, the adhesive tape 180 may be bonded to one surface of the first separator 130 where the coating layer and the adhesive layer are located between the radially outer surface 110b of the positive electrode 110 and the negative electrode 120.

Continuing with the adhesive tape 180, the base layer, the coating layer, and the adhesive layer include a porous structure, thereby allowing lithium ions of the negative electrode 120 to pass therethrough. Such a configuration minimizes lithium precipitation even when the electrode assembly 100 is charged and discharged, and thus, improves the safety of the secondary battery.

Continuing with the adhesive tape 180, a thickness of the porous base layer 181 may be 13 μm or greater, and a thickness of the adhesive layer 182 may be greater than 0 μm and less than or equal to 4 μm. Preferably, the thickness of the porous base layer 181 may be 15 μm or greater, and the thickness of the adhesive layer 182 may be greater than 0 μm and less than or equal to 3 μm. When the thickness of the porous base layer 181 is 13 μm or greater, the overall thickness of the adhesive tape 180 becomes substantially thicker, which can prevent the end portions of the negative electrode and positive electrode from damaging or piercing the separator during core impingement. Since the thickness of the adhesive layer 182 is 4 μm or less, the electrolyte solution has a high permeability and a high ion conductivity.

The adhesive tape 180 may have a length of at least 5 mm. Preferably, the length of the adhesive tape 180 may be 10 mm or greater. Furthermore, the adhesive tape 180 may overlap with the positive electrode such that at least 2 mm of adhesive tape 180 overlaps the positive electrode, and preferably 5 mm or greater overlaps the positive electrode.

The adhesive tape 180 has a porous base layer 181 facing the base layer 131 of the first separator, and the length of the porous base layer 181 and the base layer 131 of the first separator may coincide with the above ranges to achieve a desired friction coefficient between the separators, thereby suppressing electrode sliding and preserving the shape of the core part C

Because of the length of adhesive tape 180 that overlaps the positive electrode 110, the thickness of such an overlapping region where the edge portion of the positive electrode is located is increased. Such an increase further increases the friction coefficient thereby prevents sliding of the electrodes during expansion and contraction of the electrode assembly.

The secondary battery 1 according to the present invention may include an electrode assembly 100, a battery case 200, and a cap assembly 300.

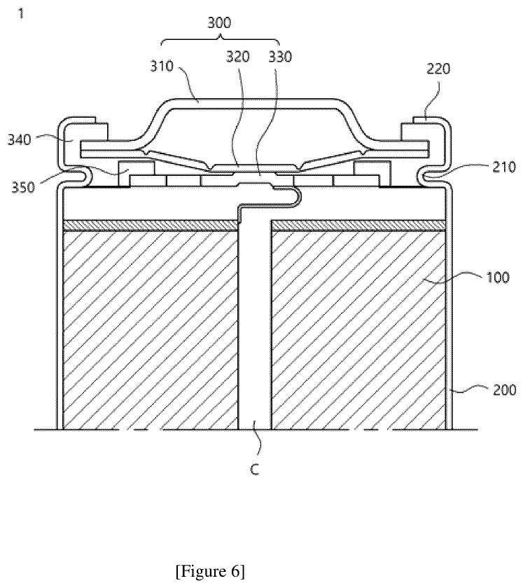

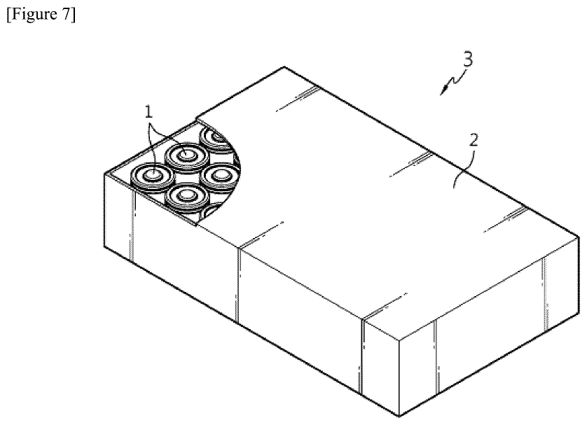

FIG. 6 illustrates the secondary battery 1 of FIG. 7 including an electrode assembly 100, a battery case 200, and a cap assembly 300, the electrode assembly being any one of the exemplary embodiments disclosed herein.

The battery case 200 may have a column structure with a space formed therein. The battery case 200 may accommodate the electrode assembly 100, i.e., the electrodes, separators, and an electrolyte solution in the internal space of the battery case 200. The battery case 200 has at least one open side (hereinafter, referred to as an opening portion) and the other side is sealed. Such sides of the battery case 200 refer top and bottom sides of battery case 200. For example, the top side may be open and the bottom side may be closed.

The opened upper side of the battery case 200 may include a beading part 210 folded toward the center of the secondary battery 1. The battery case 200 may include a crimping part 220 on an upper side of the beading part 210. That is, the crimping part 220 may be located on the uppermost side of the battery case 200.

The battery case 200 may be made of a lightweight conductive metal material such as aluminum or aluminum alloy. and may have a cylindrical shape. Specifically, the battery case 200 may have a cylindrical, prismatic, or pouch shape depending on particular applications. Cylindrical battery cases may be more suitable for accommodating a jelly-roll type electrode assembly. When the battery case has a cylindrical shape, a shape of a secondary battery including the jelly-roll type electrode assembly and a battery case for accommodating the electrode assembly may have a cylindrical shape.

According to an exemplary embodiment of the present invention, the battery case may include an electrolyte therein. Specifically, the electrolyte may include an organic liquid electrolyte, an inorganic liquid electrolyte, a solid polymer electrolyte, a gel-type polymer electrolyte, a solid inorganic electrolyte, a molten-type inorganic electrolyte that may be used in the manufacturing of the lithium secondary battery, and the like. Specifically, the electrolyte may include a non-aqueous organic solvent and a metal salt.

According to an exemplary embodiment of the present invention, the non-aqueous organic solvent may be an aprotic organic solvent such as N-methyl-2-pyrrolidinone, propylene carbonate, ethylene carbonate, butylene carbonate, dimethyl carbonate, diethyl carbonate, gamma-butyllolactone, 1,2-dimetoxy ethane, tetrahydrofuran, 2-methyltetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

According to an exemplary embodiment of the present invention, a lithium salt may be used as the metal salt, and the lithium salt may be a material that is readily soluble in the non-aqueous electrolyte solution. An anion of the lithium salt may be one or more species selected from the group consisting of F⁻, Cl⁻, I⁻, NO³−, N(CN)²⁻, BF⁴−, ClO⁴−, PF⁶−, (CF₃)₂PF⁴−, (CF₃)₃PF³−, (CF₃)₄PF²−, (CF₃)₅PF−, (CF₃)₆P⁻, CF₃SO₃−, CF₃CF₂SO³−, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

According to an exemplary embodiment of the present invention, one or more additives, for example, a haloalkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte for the improving the lifespan of the battery, increasing battery capacity, improving discharge capacity of the battery, and the like, in addition to the advantages of the above-described electrolyte components.

The cap assembly 300 may be coupled to the opened surface of the battery case 200, and may include a top cap 310, a safety vent 320, and a current interruptive device 330.

The top cap 310 is located at the top of the cap assembly 300, and may protrude in an opposite direction (lower direction) toward the center of the battery case 200. The top cap 310 may serve as an electrode terminal such that the protruding portion is electrically connected components outside of the top cap. For example, the top cap 310 may serve as a positive electrode terminal.

The top cap 310 may be coupled with a sealing gasket 340 at an edge of the top cap 310, and the sealing gasket 340 may be located inside the crimping part 220 of the battery case 200. The sealing gasket 340 improves the seal between the top cap 310 and the battery case 200.

The top cap 310 may include a protrusion that protrudes upward, a rim portion that contacts and is coupled to the sealing gasket 340, and a first connection portion connecting the protrusion and the rim portion.

The safety vent 320 is located below the top cap 310 and may be electrically connected to the top cap 310. At least a portion of a surface of the safety vent 320 facing the top cap 310 may contact the top cap 310. The safety vent 320 contacts the top cap 310 along at least a portion of its length. The portion of the safety vent 320 in contact with the top cap 310 may be coupled with the sealing gasket 340.

If the safety vent 320 is spaced apart from the top cap 310, such a space may increase from a region in contact with the top cap 310 toward the center of the safety vent 320.

The safety vent 320 may include a contact portion in contact with the top cap 310, a central portion located at the center of the safety vent 320 and in contact with the current interruptive device, and a second connection portion connecting the contact portion and the central portion. The safety vent 320 may include a bent portion (or notch) at a portion where the contact portion, the second connection portion, and the central portion are in contact.

In an exemplary embodiment, the safety vent 320 may have an end portion perpendicular to an axial direction of the battery case 200. The top cap 310 may be extend perpendicular to the axial direction of the battery case 200, similar to the safety vent 320. That is, the safety vent 320 and the top cap 310 can extend perpendicularly along a horizontal plane.

In another exemplary embodiment, the safety vent 320 may have an end portion bent to surround an outer circumferential surface of the top cap 310.

In the secondary battery 1 according to the present invention, gas and/or heat is generated as the electrode assembly 100 within the battery case 200 reacts with the electrolyte solution, thereby increasing the internal pressure within the battery case 200.

When the internal pressure of the secondary battery 1 increases above a threshold value, the safety vent 320 is forced upward toward the top cap 310, and the bent portion ruptures, thereby causing the gas inside the secondary battery 1 to be discharged.

The current interruptive device (CID) 330 is located below the safety vent 320, and at least a portion thereof may be connected to the safety vent 320.

When the safety vent 320 ruptures as the internal pressure of the secondary battery 1 increases, the current interruptive device 330 is separated from the safety vent 320 to interrupt the current.

The current interruptive device 330 may include a connection portion connected to the safety vent 320 at a central portion and protruding in a direction in which the safety vent 320 is located, i.e., upwards toward a midpoint along the length of current interruptive device 330, an edge portion excluding the connection portion, and a coupling portion connecting the connection portion and the edge portion. The coupling portion includes a plurality of coupling portions, the plurality of coupling portions spaced apart from each other.

When the safety vent 320 is deformed in the direction in which the top cap 310 is located, i.e., upward, the coupling portion may be disconnected from the safety vent 320 and the connection portion may be separated from the edge portion. That is, the connection portion is pushed upward toward the top cap 310 while being connected to the safety vent 320.

A CID gasket 350 surrounds an edge of the current interruptive device 330 and can electrically separate the safety vent 320 from the edge portion and coupling portion separately from the connection portion of the current interruptive device 330.

According to an exemplary embodiment of the present invention, a battery pack 3 including any one of the secondary batteries described above is provided. Continuing with this embodiment and referring to FIG. 7, a battery pack 3 including the secondary battery 1 in a pack housing 2 is shown. Such a battery pack has a high output and a high capacity.

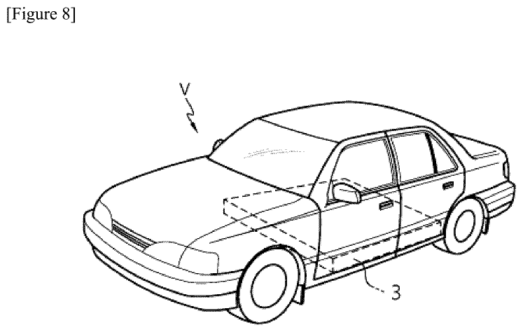

Continuing with this exemplary embodiment, a moving means, such as a vehicle, including the battery pack described above is provided and is illustrated in FIG. 8.

Because the vehicle according to the above exemplary embodiment uses the battery pack having high output/high capacity, such a vehicle has high stability and a high safety factor.

Although the present invention has been described with reference to preferred embodiments, it will be understood by one skilled in the art that various modifications and variations can be made in the present invention without departing from its technical spirit and scope.

### EXAMPLES

### Example 1

### Preparation of Electrode Assembly

A positive electrode was provided having a thickness of 154 μm. The electrode was prepared by preparing an Al foil having a thickness of 15 μm and a length of 63.9 mm in the width direction as a positive electrode current collector. A positive electrode active material slurry including an NMCA (Ni—Mn—Co—Al) composite having a Ni content of 92% or more as a positive electrode active material and CNTs as a conductive material were applied to the positive electrode current collector and allowed to dry to form a positive electrode active material layer.

Next, a negative electrode was provided having a thickness of 187 μm. The electrode was prepared by preparing a Cu foil having a thickness of 8 μm and a length of 65.1 mm in the width direction as a negative electrode current collector. A negative electrode active material slurry including artificial graphite and natural graphite as negative electrode active materials in 50 parts by weight, respectively, was applied to the negative electrode current collector and was allowed to dry to form a negative electrode active material layer.

Two separators each having a coating layer including Al₂O₃ as an inorganic component, a PVdF-based binder as a binder component, and a lithium salt formed on one surface of a sheet-like polyethylene base layer were prepared as the first separator and the second separator, respectively.

Before winding a jelly-roll type electrode assembly, the base layers of the first separator and the second separator were overlapped such that the first and second base layers face each other, and the first separator and the second separator were arranged such that an overlapping portion, in which the first and second base layers face each other, extends long enough to wrap approximately three rotations around a winding core of an electrode assembly. These three rotations extend in a direction opposite a “winding direction,” the “winding direction” being the direction the separators and electrodes are wound extending outward from a central core, rather than inward toward the central core. In the electrode assembly of FIG. 2, the winding direction is counterclockwise. The winding core may be a core of the jelly-roll electrode assembly with an outer circumference of approximately 10 mm.

After the first separator and the second separator have been wound approximately three turns toward the central core (C), the separators may be folded back over themselves to extend in the winding direction to start winding. The negative electrode and the positive electrode were sequentially introduced within the first and second separators with the negative electrode being introduced first, i.e., closer to the central core (C), to prepare a jelly-roll type electrode assembly. The core part of the jelly-roll type electrode assembly was formed to have a structure shown in FIGS. 2 and 3 by interposing the clockwise extending extensions of the first separator and the second separator between the second separator located on one surface of the positive electrode in the direction of the winding axis, i.e., counterclockwise direction, and on one surface of the negative electrode to provide a separator overlapping portion. An adhesive tape was placed on an opposite surface to the surface on which the extensions are interposed, i.e., between the first separator and the negative electrode.

The spacing distance L between the longitudinal end portion of the separator overlapping portion and the longitudinal end portion of the positive electrode was 3 mm, and the length (L+L′=2L), in the longitudinal direction, of the separator overlapping portion was 6 mm. The circumference of the inner circumferential surface of the prepared jelly-roll type electrode assembly was approximately 10 mm.

The adhesive tape had a porous base layer thickness of 16 μm, an adhesive layer thickness of 3 μm, and a length of 18 mm.

### Preparation of Secondary Battery

A secondary battery was prepared by inserting the jelly-roll type electrode assembly into a cylindrical battery case, injecting an electrolyte solution in which ethylene carbonate (EC), dimethyl carbonate (DMC), and ethyl methyl carbonate (EMC) were mixed at a weight ratio of 4:9:3 and LiPF₆ was dissolved to be 15 wt % into the battery case, and sealing the cylindrical battery case with a cap assembly.

### Example 2

A jelly-roll type electrode assembly and a secondary battery were prepared in the same manner as in Example 1, except that an adhesive tape of 10 mm was used.

### Example 3

A jelly-roll type electrode assembly and a secondary battery were prepared in the same manner as in Example 1, except that an adhesive tape of 15 mm was used.

### Example 4

A jelly-roll type electrode assembly and a secondary battery were prepared in the same manner as in Example 1, except that an adhesive tape of 5 mm was used.

### Comparative Example 1

A jelly-roll type electrode assembly and a secondary battery were prepared in the same manner as in Example 1, except that the thickness of the porous base layer of the adhesive tape was 11 μm and the thickness of the adhesive layer was 5 μm.

### Comparative Example 2

A jelly-roll type electrode assembly and a secondary battery were prepared in the same manner as in Example 1, except that an adhesive tape was not attached between the first separator and the negative electrode.

### Experimental Examples

Experimental Example 1—Core Impingement Evaluation

Cycle stability Evaluation Depending on the Thickness of the Adhesive Tape

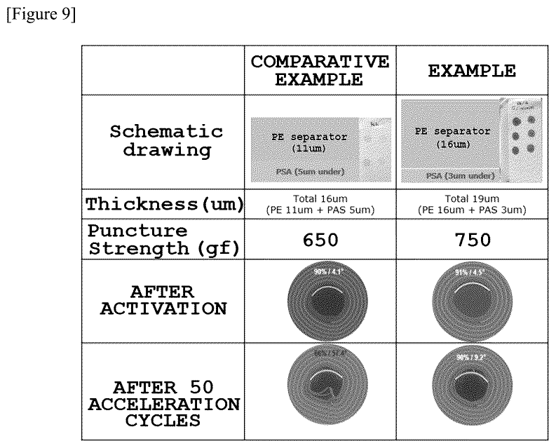

The secondary batteries prepared in Example 1 and Comparative Example 1 were subjected to 2 cycles under conditions of 4.2 V-2.5 V, 0.2 C charging, and 0.2 C discharging, respectively, leading to preparation of activated secondary batteries. Thereafter, each of the activated secondary batteries was subjected to 50 cycles under conditions of 4.3 V−2.5 V 1 C/1 C@24° C. Then, for the short-term cycle stability evaluation, the core parts of the prepared secondary batteries were subjected to computed tomography (CT) to check presence or absence of the core impingement. The CT images are shown in FIG. 9.

### Cycle Stability Evaluation Depending on the Length of Adhesive Tape

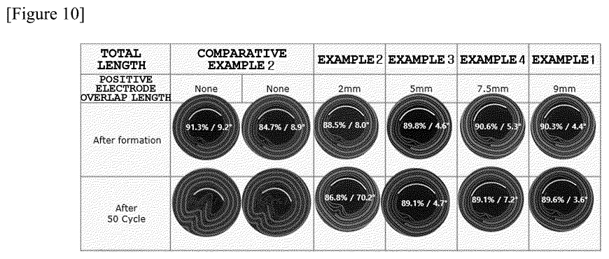

The secondary batteries prepared in Example 1 and Comparative Example 2 were subjected to 2 cycles under conditions of 4.2 V−2.5 V, 0.2 C charging, and 0.2 C discharging, respectively, leading to preparation of activated secondary batteries. Thereafter, each of the activated secondary batteries was subjected to 50 cycles under conditions of 4.3 V−2.5 V 1 C/1 C@24° C. Then, for the short-term cycle stability evaluation, the core parts of the prepared secondary batteries were subjected to computed tomography (CT) to check for the presence of core impingement. The CT images are shown in FIG. 10.

### Core Impingement Evaluation

Core impingement can be determined and evaluated for the secondary batteries of Example 1 and Comparative Example 1 by using the following method.

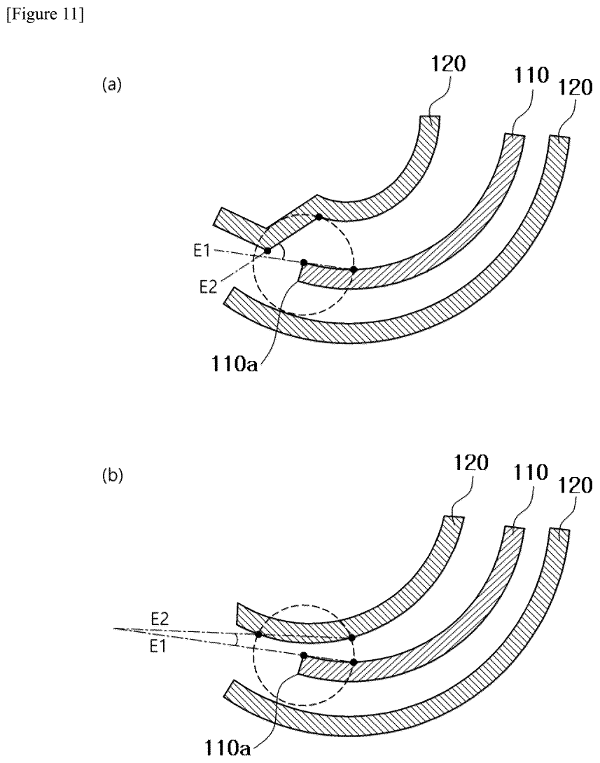

FIG. 11 schematically shows a method for evaluating whether core impingement has occurred. Specifically, FIG. 11(a) schematically shows a method for evaluating whether core impingement has occurred when deformation occurred in the negative electrode, and FIG. 11(b) schematically shows a method for evaluating whether the core impingement has occurred when deformation did not occur in the negative electrode.

### 2-1) When the Negative Electrode is Deformed

On the radially inner surface of the positive electrode 110, a first extension line E1 is drawn by extending a straight line connecting the longitudinal end portion 110a of the positive electrode and a point 5 mm spaced from the end portion.

At the core part of the jelly-roll type electrode assembly, on the surface of the negative electrode 120 facing the radially inner surface of the positive electrode, a second extension line E2 is drawn by extending a straight line connecting two points where a direction of curvature changes within a spacing distance of 5 mm from the longitudinal end portion 110a of the positive electrode.

### 2-2) When There is no Deformation in the Negative Electrode

At the core part of the jelly-roll type electrode assembly, on the surface of the negative electrode 120 facing the radially inner surface of the positive electrode, a second extension line E2 is drawn by extending a straight line connecting two points 5 mm spaced from the longitudinal end portion 110a of the positive electrode.

3) When an angle from the first extension line E1 to the second extension line E2 in a counterclockwise direction with respect to the intersection of the first extension line E1 and the second extension line E2 exceeds 25°, it was evaluated that core impingement occurred.

On the contrary, when an unknown secondary battery (unknown cell) is acquired, the above method for evaluating whether the core impingement has occurred may be applied in a manner of evaluating whether the core impingement has occurred at the time of initial acquisition, reevaluating whether the core impingement has occurred after a number of cycles, such as 50 cycles, and comparing and analyzing the result with the core impingement conditions of the secondary battery of the exemplary embodiment according to the present invention.

FIG. 9 is a CT image showing results of the cycle stability evaluation of the secondary batteries according to Example 1 and Comparative Example 1, depending on the thickness of the adhesive tape, and FIG. 10 is a CT image showing results of the cycle stability evaluation of the secondary batteries according to of Examples 1 to Example 4 and Comparative Example 2, depending on the length of the adhesive tape.

Referring to FIGS. 9 and 10, it was confirmed that core impingement did not occur in the secondary battery prepared in Example 1, in the cycle stability evaluation depending on the thickness of the adhesive tape and the cycle stability evaluation depending on the length, and that core impingement did not occur in the secondary batteries prepared in Examples 2 to 4, in the cycle stability evaluation depending on the length of the adhesive tape.

It was confirmed that core impingement occurred in the secondary battery prepared in Comparative Example 1, in the cycle stability evaluation depending on the thickness, and that core impingement occurred in the secondary battery prepared in Comparative Example 2, in the cycle stability evaluation depending on the length.

Specifically, it can be confirmed that in both Comparative Example 1 and Comparative Example 2, core impingement did not occur or core impingement occurred a minimal amount after activation. After 50 cycles, it was confirmed that the damage to the negative electrode and separator by the longitudinal end portion of the positive electrode, i.e., the occurrence frequency and degree of core impingement due to contraction/expansion of the electrode assembly considerably increased in Comparative Example 1 and Comparative Example 2.

In Example 1, the thickness of the porous base layer is substantially thick, such that the puncture strength is higher than that of Comparative Example 1, and therefore, puncture of the first separator located between the positive electrode and the negative electrode due to the positive electrode and the negative electrode can be prevented.

In addition, in Example 1 and Comparative Example 1, the electrolyte solution permeability was confirmed by placing a specimen whose color changes upon contact with the acidic component of the electrolyte solution between the adhesive layer and the porous base layer. As a result, in Example 1, the adhesive layer was provided substantially thin, ensuring ion conductivity through the adhesive tape, and thus, it was confirmed that the specimen between the porous base layer and the adhesive layer was changed to red, thereby indicating the electrolyte solution permeability.

In addition, Example 1 can reduce core impingement by increasing the frictional force (stress) between the negative electrode and the separator when the negative electrode moves over a number of cycles because of the thickness of the adhesive tape.

The secondary batteries prepared in Examples 2 to 4 had a slight difference in core impingement after activation and after 50 cycles. In particular, when the overlapping length of the adhesive tape and the positive electrode was 5 mm or greater, the core impingement was 89% or higher.

With this, it can be seen that when the thickness of the adhesive tape between the first separator and the negative electrode is 19 μm or greater and the length is 5 mm or greater, a higher friction coefficient can be achieved, as compared to when the adhesive tape is not located between the first separator and the negative electrode or the thickness of the adhesive tape is less than 19 μm, and the sliding of the electrode is suppressed to prevent damage to the negative electrode and separator when the electrode undergoes contraction/expansion.

The foregoing detailed description is intended to illustrate and explain the present invention. In addition, the foregoing description is discloses embodiments of the present invention, and as described above, the present invention can be used in various other combinations, changes and environments, and can be changed and modified within the scope of the concept of the invention disclosed in the present specification, within the scope equivalent to the above disclosure, and/or within the scope of skill or knowledge in the art. Accordingly, the foregoing detailed description of the invention is not intended to limit the invention to the disclosed embodiments. Also, the appended claims should be construed to include additional embodiments.

### IDENTIFICATION OF SELECT REFERENCE NUMERALS

1: secondary battery
2: pack housing
3: battery pack
100: electrode assembly
110: positive electrode
110a: longitudinal end portion of positive electrode
111: positive electrode current collector
112: positive electrode active material
120: negative electrode
120a: longitudinal end portion of negative electrode
121: negative electrode current collector
122: negative electrode active material
130: first separator
131: first separator base layer
132: first separator coating layer
140: second separator
141: second separator base layer
142: second separator coating layer
143: longitudinal end portion of second separator
150: first electrode tab
160: second electrode tab
170: third electrode tab
180: adhesive tape
181: tape base layer
182: adhesive layer
200: battery case
210: beading part
220: crimping part
300: cap assembly
310: top cap
320: safety vent
330: current interruptive device
340: sealing gasket
350: CID gasket
C: core part
B: bend point
S: separator overlapping portion
S1: first interface
S2: second interface
Sa: one circumferential end of separator overlapping portion
Sb: opposing circumferential end of separator overlapping portion
L, L′: spacing distance between longitudinal end portion of separator overlapping portion and longitudinal end portion of positive electrode
E1: first extension line
E2: second extension line

What is claimed is:

1. A jelly-roll electrode assembly comprising:
a first separator;
a second separator;
a negative electrode; and
a positive electrode;
wherein the first separator and second separator are positioned adjacent each other in a separator overlapping portion and extend with at least three layers in a first direction toward a core of the electrode assembly between an inner surface of the positive electrode and an outer surface of the negative electrode, and
wherein an adhesive tape is located in at least one of a location between the outer surface the positive electrode and an inner surface of the first separator, and a location between an outer surface of the negative electrode and the inner surface of the first separator.

2. The jelly-roll type electrode assembly of claim 1, wherein the first separator, the negative electrode, and the second separator each have a greater length than a length of the positive electrode.

3. The jelly-roll type electrode assembly of claim 1, wherein the separator overlapping portion is defined as a region extending in both the first and second directions from a terminal end of the positive electrode.

4. The jelly-roll type electrode assembly of claim 1, wherein the first separator and the second separator
are bent together in the core to extend in a second direction opposite the first direction to extend between the inner surface of the positive electrode and an outer surface of the second separator.

5. The jelly-roll type electrode assembly of claim 1, wherein the separator overlapping portion includes a first interface in which the second separator extending in a first direction and the second separator extending in the second direction directly contact each other, and a second interface in which the second separator extending in the first direction and the first separator extending in the first direction directly contact each other, and
wherein the first interface and the second interface each have a friction coefficient of at least 0.4.

6. The jelly-roll type electrode assembly of claim 5, wherein the friction coefficient of the first interface is at least 0.6.

7. The jelly-roll type electrode assembly of claim 5, wherein the first separator and the second separator each comprise a coating layer provided on at least one of the respective inner and outer surfaces thereof, such a friction coefficient of the coating layer is higher than a friction coefficient of an uncoated portion of at least one of the inner and outer surfaces of the first and second separators.

8. The jelly-roll type electrode assembly of claim 5, wherein the first separator and the second separator each comprise a coating layer provided on at least one of the respective inner and outer surfaces thereof, the coating layer including an inorganic component, a binder component, and a lithium salt.

9. The jelly-roll type electrode assembly of claim 5, wherein the first separator and the second separator each comprise a coating layer provided on at least one of the respective inner and outer surfaces thereof,
wherein the first interface is defined between the coating layer of the second separator extending in the first direction and the coating layer of the second separator extending in the second direction such that each coating layer at the first interface directly contacts the other.

10. The jelly-roll type electrode assembly of claim 5, wherein the first separator and the second separator each comprise a coating layer provided on at least one of the respective inner and outer surfaces thereof,
wherein the second interface is defined between an uncoated surface of the second separator and an uncoated surface of the first separator such that each uncoated layer at the second interface directly contacts the other.

11. The jelly-roll type electrode assembly of claim 5, wherein the first interface is defined between a portion of the second separator abutting the negative electrode and a portion of the second separator abutting the first separator.

12. The jelly-roll type electrode assembly of claim 5, wherein the second interface is defined between a portion of the first separator abutting a terminal end of the positive electrode and a portion of the second separator spaced away from a terminal end of the positive electrode by the portion of the first separator.

13. The jelly-roll type electrode assembly of claim 1, wherein the separator overlapping portion extends at least approximately 108° around a circumference of the electrode assembly.

14. The jelly-roll type electrode assembly of claim 1, wherein the separator overlapping portion has a first end extending in a first direction away from a terminal end of the positive electrode and a second end extending in a second, opposite direction from the terminal end of the positive electrode, wherein at least one of the first and second ends extends away from the terminal end of the positive electrode by at least 3 mm.

15. The jelly-roll type electrode assembly of claim 1, wherein the adhesive tape comprises a porous base layer and an adhesive layer disposed on the porous base layer.

16. The jelly-roll type electrode assembly of claim 15, wherein the porous base layer has a thickness of at least 13 μm, and the adhesive layer has a thickness between 0 μm and approximately 4 μm.

17. The jelly-roll type electrode assembly of claim 1, wherein the adhesive tape has a length of at least 5 mm.

18. A secondary battery comprising:
the electrode assembly of claim 1;
a battery case configured to house the electrode assembly; and
a cap assembly coupled to an opening of the battery case.

19. The secondary battery of claim 18, wherein the battery case is cylindrical.
